(19) United States
(12) Patent Application Publication
(10) Pub. No.: US 2020/0030804 A1
(43) Pub. Date: Jan. 30, 2020

(54) LIGHT INDUCED DIELECTROPHORESIS (LIDEP) DEVICE

(71) Applicant: TECHTRON TECHNOLOGY CO., LTD., NEW TAIPEI CITY (TW)

(72) Inventors: Hung-Wei WU, TAINAN CITY (TW); Cheng-Yuan HUNG, KAOHSIUNG CITY (TW); Chang-Sin YE, TAINAN CITY (TW)

(21) Appl. No.: 16/591,643

(22) Filed: Oct. 3, 2019

Related U.S. Application Data
(63) Continuation-in-part of application No. 15/657,202, filed on Jul. 23, 2017.

(30) Foreign Application Priority Data
Oct. 27, 2016 (TW) 105134720

(51) Int. Cl. B01L 3/00; B03C 5/00; G01N 15/02

(52) U.S. Cl. CPC B01L 3/502761; B03C 5/005; B01L 2200/0652; B01L 2400/0424; G01N 15/0266

(57) ABSTRACT

A light induced dielectrophoresis (LIDEP) includes a LIDEP chip, a patterned light source, and an opaque cartridge. The LIDEP chip includes a first electrode layer, a second electrode layer, a semiconductor layer, and a flow channel layer. The flow channel layer defines a first channel, a second channel and a third channel intersected at a confluence. The first channel is configured to guide a liquid. The flow channel layer further defines a projection region including the confluence. The patterned light source is configured to project a patterned light on the projection region for guiding the first micro-particles and the second micro-particles located within the confluence to move toward the second channel and the third channel, respectively. The opaque cartridge covers the LIDEP chip and has an opening. The vertical projection of the opening overlaps the projection region.

### RELATED APPLICATIONS

This application is a continuation-in-part application of U.S. application Ser. No. 15/657,202, filed on Jul. 23, 2017, which claims priority to Taiwan Patent Application Serial Number 105134720, filed on Oct. 27, 2016, which is herein incorporated by reference.

### BACKGROUND

### Field of Invention

The present invention relates to a light induced dielectrophoresis (LIDEP) device. More particularly, the present invention relates to a LIDEP device configured to perform a sorting process on a liquid including different micro-particles by a LIDEP force.

### Description of Related Art

Medical diagnosis uses various medical analysis instruments to analyze several kinds of the micro-particles and then uses the analysis results to assist in evaluating the physiological status of the biological body. If only one kind of the micro-particles need to be analyzed, a sorting process needs to be performed on the liquid including different kinds of the micro-particles. However, if the sorting results are not good, the subsequent analysis instruments will be seriously affected, thereby reducing the accuracy of the analysis results of the subsequent analysis instruments.

In view of this, a control technology using the LIDEP force to drive a phoresis of the micro-particles has been studied extensively. The control technology needs to be performed on a chip including a photoconductive material. A method of the control technology is to project an optical pattern on the chip, thereby generating the LIDEP force to drive the phoresis of the micro-particles. The control technology can simplify the complicated process of the pretreatment of the biologic samples.

### SUMMARY

An objective of the invention is to provide a LIDEP device configured to perform a sorting process on a liquid including different kinds of the micro-particles, thereby benefiting the subsequent analysis instruments to analyze the micro-particles.

One aspect of the invention is directed to a LIDEP device including a LIDEP chip, a patterned light source, and an opaque cartridge. The LIDEP chip includes a first electrode layer, a second electrode layer, a semiconductor layer, and a flow channel layer. The second electrode layer is disposed opposite to the first electrode layer. The semiconductor layer is disposed between the first electrode layer and the second electrode layer. The flow channel layer is disposed between the second electrode layer and the semiconductor layer. The flow channel layer defines a first channel, a second channel and a third channel intersected at a confluence. The first channel, the second channel and the third channel are configured to guide a liquid, plural first micro-particles and plural second micro-particles, respectively. The liquid includes the first micro-particles and the second micro-particles. The flow channel layer further defines a projection region including the confluence. The patterned light source is configured to project a patterned light on the projection region of the flow channel layer for changing an electric field generating between the first electrode layer and the second electrode layer. A pattern of the patterned light is changed according to a structure of the flow channel layer. The electric filed is configured to guide the first micro-particles and the second micro-particles located within the confluence to move toward the second channel and the third channel, respectively. The opaque cartridge covers the LIDEP chip and has an opening. The vertical projection of the opening projected on the flow channel layer overlaps the projection region.

In accordance with some embodiments of the invention, each of the first electrode layer and the second electrode layer includes a transparent conductive material.

In accordance with some embodiments of the invention, the semiconductor layer includes an indirect bandgap material, and a crystal structure of the semiconductor layer is an amorphous structure, a microcrystalline structure, a polycrystalline structure, or a single crystal structure.

In accordance with some embodiments of the invention, a thickness of the flow channel layer is between 30 μm and 150 μm, and a size of the projection region is between 1 mm×1 mm and 10 mm×10 mm.

In accordance with some embodiments of the invention, the flow channel layer further defines an injection opening, a first outflow opening and a second outflow opening, in which the liquid is injected into the first channel through the injection opening, and the first micro-particles flow out from the first outflow opening through the second channel, and the second micro-particles flow out from the second outflow opening through the third channel.

In accordance with some embodiments of the invention, the LIDEP chip further includes a first buffer layer and a second buffer layer, in which the first electrode layer is disposed on the first buffer layer, and the second buffer layer is disposed on the second electrode layer.

In accordance with some embodiments of the invention, the LIDEP chip further includes an upper substrate and a lower substrate, in which the upper substrate is disposed on the second buffer layer, and the first buffer layer is disposed on the lower substrate.

In accordance with some embodiments of the invention, the upper substrate is a transparent substrate, and the lower substrate is the transparent substrate.

In accordance with some embodiments of the invention, the first buffer layer is configured to enhance a lattice match between the first electrode layer and the lower substrate, and the second buffer layer is configured to enhance the lattice match between the second electrode layer and the upper substrate.

In accordance with some embodiments of the invention, the opaque cartridge has an injection inlet, a first outflow outlet, and a second outflow outlet, in which the injection inlet is configured to allow the liquid to be injected into the LIDEP chip, and the first outflow outlet is configured to allow the first micro-particles to flow out of the LIDEP chip, and the second outflow outlet is configured to allow the second micro-particles to flow out of the LIDEP chip.

In accordance with some embodiments of the invention, a sheet resistance of each of the first electrode layer and the second electrode layer is between 4Ω/□ and 7 Ω/□.

In accordance with some embodiments of the invention, when the patterned light source projects the patterned light on the projection region, the projection region includes an illuminated region and a non-illuminated region.

In accordance with some embodiments of the invention, a resistance of the illuminated region is different from a resistance of the non-illuminated region.

In accordance with some embodiments of the invention, the resistance of the illuminated region is lower than the resistance of the non-illuminated region.

In accordance with some embodiments of the invention, a difference between the resistance of the illuminated region and the resistance of the non-illuminated region causes a periodic stepped-impedance effect for guiding at least one of the first micro-particles and the second micro-particles.

In accordance with some embodiments of the invention, the LIDEP chip further includes a biocompatibility optimizing layer, and the semiconductor layer is coated with the biocompatibility optimizing layer.

In accordance with some embodiments of the invention, the biocompatibility optimizing layer includes titanium oxide (TiO₂), aluminum oxide (Al₂O₃), zirconium oxide (ZrO₂), hafnium oxide (HfO₂), and combination thereof.

In accordance with some embodiments of the invention, a thickness of the biocompatibility optimizing layer is between 1 nm and 100 nm.

In accordance with some embodiments of the invention, the semiconductor layer includes a direct bandgap material or a nanocrystalline material.

In accordance with some embodiments of the invention, a crystal structure of the semiconductor layer is an amorphous and nanocrystalline structure.

### BRIEF DESCRIPTION OF THE DRAWINGS

The invention can be more fully understood by reading the following detailed description of the embodiment, with reference made to the accompanying drawings as follows:

FIG. 1A is a cross-sectional view of the LIDEP device according to an embodiment of the present invention.

FIG. 1B is a bottom view of the LIDEP device according to the embodiment of the present invention.

FIG. 2 is a plan view of a flow channel layer of a LIDEP chip according to the embodiment of the present invention.

FIGS. 3A-3G are schematic views of several patterns of a patterned light according to the embodiment of the present invention.

FIG. 4A is a schematic view of a structure of the flow channel layer and a pattern of its corresponding patterned light according to the embodiment of the present invention.

FIG. 4B is a schematic view of a structure of the flow channel layer and a pattern of its corresponding patterned light according to the embodiment of the present invention.

FIG. 5A is a schematic view of an electric field distribution of the LIDEP chip according to the embodiment of the present invention, in which the LIDEP chip is not projected by the patterned light source.

FIG. 5B is a schematic view of the electric field distribution of the LIDEP chip projected by the patterned light source according to the embodiment of the present invention.

FIG. 6A is a schematic view of a distribution of the first micro-particles and the second micro-particles of the LIDEP chip according to the embodiment of the present invention, in which the LIDEP chip is not projected by the patterned light source.

FIG. 6B is a schematic view of the distribution of the first micro-particles and the second micro-particles of the LIDEP chip projected by the patterned light source according to the embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

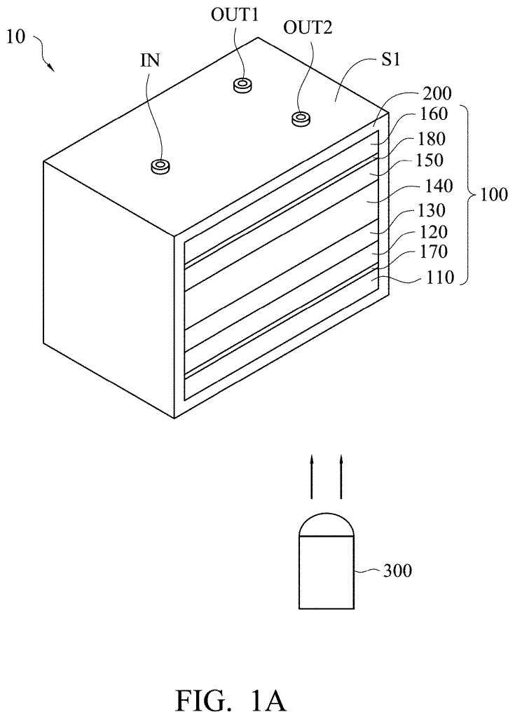

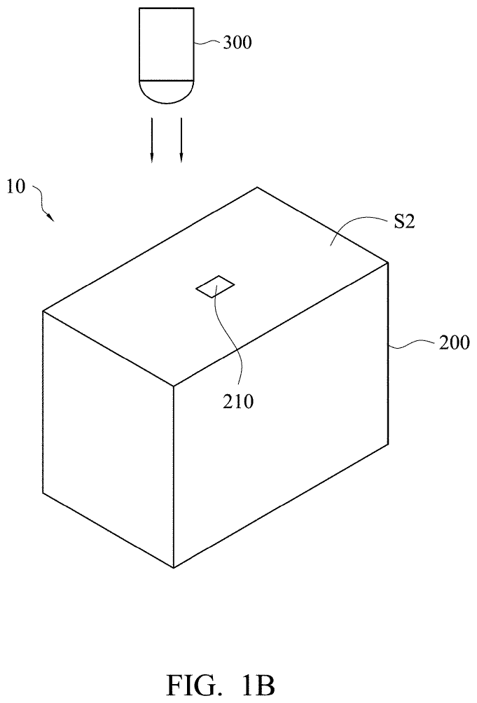

FIG. 1A is a cross-sectional view of the LIDEP device 10 according to an embodiment of the present invention. The LIDEP device 10 includes a LIDEP chip 100 and an opaque cartridge 200. The LIDEP chip 100 includes a lower substrate 110, a first electrode layer 120, a semiconductor layer 130, a flow channel layer 140, a second electrode layer 150, and an upper substrate 160. The lower substrate 110 is a transparent substrate which is permeable to light, such as a glass substrate or a plastic substrate, but embodiments of the present invention are not limited thereto.

The first electrode layer 120 is disposed on the lower substrate 110. The first electrode layer 120 includes a transparent conductive material, such as indium tin oxide (ITO), indium zinc oxide (IZO), or other similar conductive materials. In some embodiments of the present invention, a sheet resistance of the first electrode layer 120 may be 4Ω/□ (ohms per square) to 7 Ω/□.

The second electrode layer 150 is disposed on the flow channel layer 140. The second electrode layer 150 includes a transparent conductive material, such as indium tin oxide (ITO), indium zinc oxide (IZO), or other similar conductive materials. In some embodiments of the present invention, a sheet resistance of the second electrode layer 150 may be 4Ω/□ to 7Ω/□. The upper substrate 160 is disposed on the second electrode layer 150. The upper substrate 160 is the transparent substrate which is permeable to light, such as the glass substrate or the plastic substrate, but embodiments of the present invention are not limited thereto.

The semiconductor layer 130 is disposed on the first electrode layer 120. The semiconductor layer 130 includes an indirect bandgap material (such as silicon, germanium), a direct bandgap material (such as cadmium sulfide), a nanocrystalline material, or other similar materials. A crystal structure of the semiconductor layer 130 is an amorphous structure, an amorphous and nanocrystalline structure, a microcrystalline structure, a polycrystalline structure, or a single crystal structure. It is noted that, in comparison with the semiconductor layer 130 with the amorphous structure, the semiconductor layer 130 with the amorphous and nanocrystalline structure has a better photo-degradation ability and a stable conductivity, thereby improving stability of the LIDEP chip 100 so as to optimize the sorting result.

The LIDEP chip 100 is configured to perform a sorting process on a liquid including different kinds of the micro-particles. In some embodiments of the present invention, the micro-particles can be the biological cells, the air particles, the impurities in water or the dielectric powders. After the liquid including plural first micro-particles and plural second micro-particles is injected into the LIDEP chip 100, when a light patterned source 300 is projected on the LIDEP chip 100, a distribution of an internal electric field of the LIDEP chip 100 changes due to an effect of the light patterned source 300. Then, different dielectrophoresis (DEP) forces act on the first micro-particles and the second micro-particles, such that the first micro-particles and the second micro-particles move to different positions. Therefore, the first micro-particles and the second micro-particles in the liquid which is injected into the LIDEP chip 100 can be sorted.

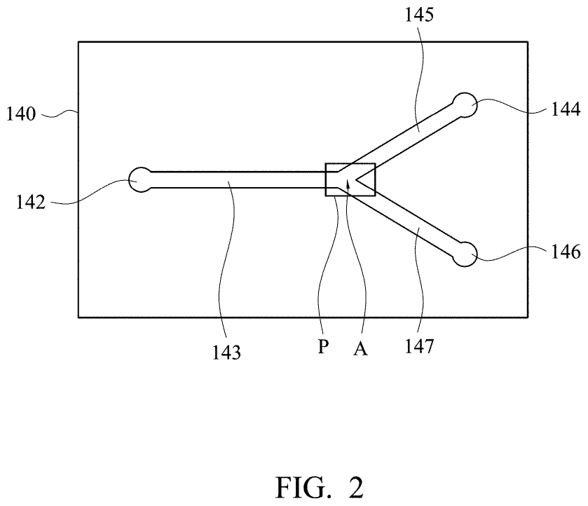

The flow channel layer 140 is disposed on the semiconductor layer 130. A material for forming the flow channel layer 140 may be polydimethylsiloxane (PDMS), polymethyl methacrylate (PMMA), or another suitable material. Referring to FIG. 1 and FIG. 2, FIG. 2 is a plan view of the flow channel layer 140 of the LIDEP chip 100 according to the embodiment of the present invention. The flow channel layer 140 defines an injection opening 142, a first outflow opening 144, a second outflow opening 146, a first channel 143, a second channel 145 and a third channel 147. The first channel 143, the second channel 145 and the third channel 147 are intersected at a confluence A. The liquid is injected into the flow channel layer 140 through the injection opening 142. The first channel 143 is configured to guide the liquid to flow toward the confluence A. If the first micro-particles and the second micro-particles in the liquid within the confluence A are affected by the change of the internal electric field, the first micro-particles and the second micro-particles move toward different directions, thereby guiding the first micro-particle to move in a direction from the confluence A toward the second channel 145 and guiding the second micro-particle to move in a direction from the confluence A toward the third channel 147. Thus, when the liquid is continually injected into the flow channel layer 140 through the injection opening 142, the second channel 145 can guide the first micro-particles to flow out of the LIDEP chip 100 through the first outflow opening 144, and the third channel 147 can guide the second micro-particles to flow out of the LIDEP chip 100 through the second outflow opening 146.

Referring to FIG. 1, the opaque cartridge 200 is located at the outer portion of the LIDEP chip to cover the LIDEP chip 100. In addition, a top surface S1 of the opaque cartridge 200 has an injection inlet IN, a first outflow outlet OUT1, and a second outflow outlet OUT2. The injection inlet IN is configured to allow the liquid to be injected into the LIDEP chip 100 through the injection opening 142. The first outflow outlet OUT1 is configured to allow the first micro-particles to flow out of the LIDEP chip 100 through the first outflow opening 144. The second outflow outlet OUT2 is configured to allow the second micro-particles to flow out of the LIDEP chip 100 through the second outflow opening 146. It is noted that the positions of the vertical projections of the injection inlet IN, the first outflow outlet OUT1, and the second outflow outlet OUT2 of the opaque cartridge 200 match the positions of the injection opening 142, the first outflow opening 144, and the second outflow opening 146, respectively.

Referring to FIG. 2, the flow channel layer 140 further defines a projection region P. A patterned light source 300 is configured to project a patterned light (not shown) on the projection region P of the flow channel layer 140. The projection region P includes the confluence A. In some embodiments of the present invention, a size of the projection region is 1.5 mm×1.5 mm, but embodiments of the present invention are not limited thereto.

FIG. 1B is a bottom view of the LIDEP device 10 according to the embodiment of the present invention. A bottom surface S2 of the opaque cartridge 200 has an opening 210. The vertical projection of the opening 210 on the flow channel layer 140 overlaps the projection region P. Therefore, the patterned light projected by the patterned light source 300 can be projected on the projection region P of the flow channel layer 140 through the opening 210. It is noted that the opaque cartridge 200 is made of an opaque material. Thus, other lights which may cause interference are blocked from the LIDEP chip 100 except for the patterned light projected into the LIDEP chip 100 through the opening 210.

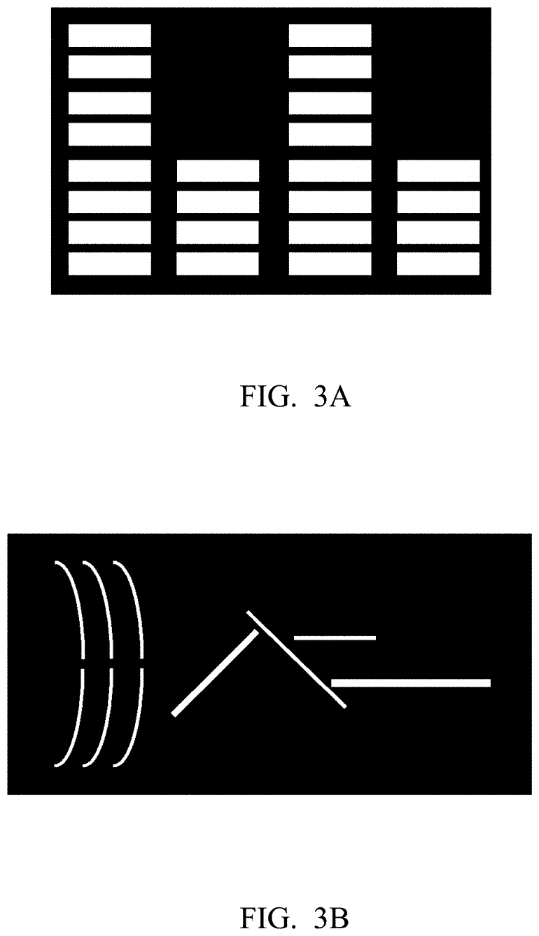

It is noted that a pattern of the patterned light projected by the patterned light source 300 may change. The pattern of the patterned light projected by the patterned light source 300 is compatible with the LIDEP chip 100, such that the first micro-particles and the second micro-particles in the liquid of the LIDEP chip 100 can be sorted. FIGS. 3A-3G are schematic views of several patterns of the patterned light according to the embodiment of the present invention. Each of the patterns as shown in FIGS. 3A-3G is an induced pattern. The patterns as shown in FIGS. 3A-3G include a combined pattern. Specifically, the patterns as shown in FIGS. 3A and 3C include a ladder pattern, the patterns as shown in FIGS. 3B, 3E and 3F include a scissor pattern, the patterns as shown in FIGS. 3D and 3G include a T&S pattern. It is noted that the patterns as shown in FIGS. 3A-3G are exemplary. In actual operation, the pattern of the patterned light projected by the patterned light source 300 may change according to several operation factors, such as a combination of the first micro-particles and the second micro-particles or a structure of the flow channel layer 140 of the LIDEP chip 100. In other words, the patterns of the patterned light projected by the patterned light source 300 are not limited to the patterns as shown in FIGS. 3A-3G.

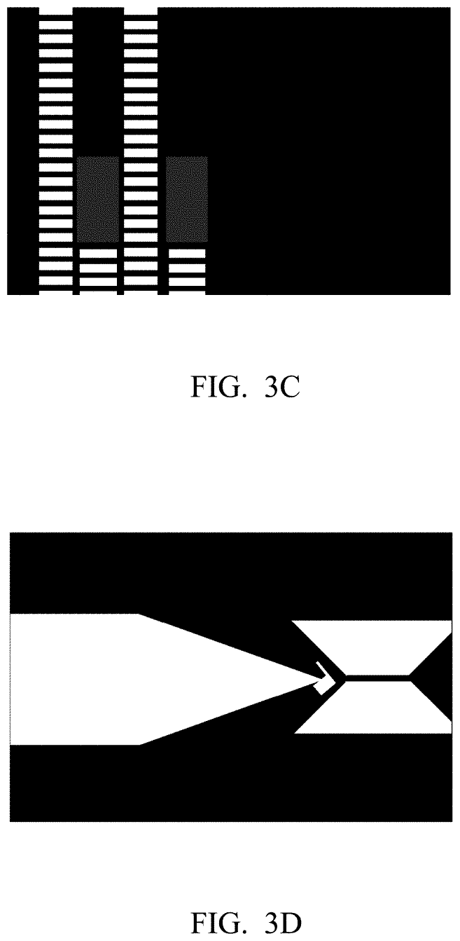

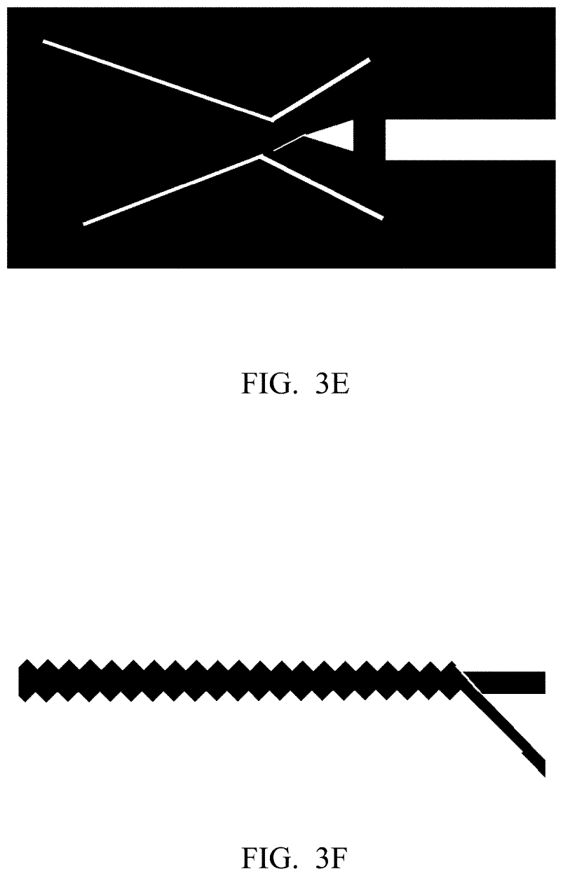

Regarding that the pattern of the patterned light is changed according to the structure of the flow channel layer 140 of the LIDEP chip 100, the following is used to illustrate how to design the pattern of the patterned light according to the structure of the flow channel layer 140. When the patterned light source 300 projects the patterned light on the projection region P of the flow channel layer 140, due to the designed pattern of the patterned light, the projection region P of the flow channel layer 140 includes an illuminated region (i.e., a bright region) and a non-illuminated region (i.e., a dark region). A resistance of the illuminated region is different from a resistance of the non-illuminated region. Specifically, the resistance of the illuminated region is lower than the resistance of the non-illuminated region. A difference between the resistance of the illuminated region and the resistance of the non-illuminated region of the projection region P of the flow channel layer 140 causes a periodic stepped-impedance effect, such that the surfaces of the first micro-particles and the second micro-particles accumulate electric charges of different densities, thereby guiding the first micro-particles and/or the second micro-particles. Since the different projected patterns generate different resistance difference on projection region P of the flow channel layer 140, the pattern of the patterned light projected by the patterned light source 300 is required to be designed according to the corresponding structure of the flow channel layer 140 of the LIDEP chip 100, so as to realize optimal sorting result. FIGS. 4A-4B are schematic views showing different structures of the flow channel layer 140 and patterns of its corresponding patterned light according to the embodiment of the present invention.

As shown in FIG. 4A, when the structure of the flow channel layer 140 is Y shape, the pattern of the patterned light projected by the patterned light source 300 is designed to be plural oblique lines with a direction from the upper-right to the bottom-left. That is, when the pattern of the patterned light as shown in FIG. 4A is projected on the projection region P of the flow channel layer 140 with the structure as shown in FIG. 4A, one of the first micro-particles and the second micro-particles in the liquid are affected by the periodic stepped-impedance effect, thereby guiding the one of the first micro-particles and the second micro-particles to move downward, such that the one of the first micro-particles and the second micro-particles flow out of the LIDEP chip through the outflow opening located at a bottom-right corner of the structure of the flow channel layer 140 as shown in FIG. 4A.

As shown in FIG. 4B, when the structure of the flow channel layer 140 is y shape, the pattern of the patterned light projected by the patterned light source 300 is designed to be plural special shapes (noted that FIG. 4B only shows one special shape), each special shape includes four intersecting lines, and each special shape is clockwise rotated. The rotation rate is related with a flow rate of the liquid injected into the LIDEP chip. For example, the rotation rate may be 1 rpm (revolutions per minute) to 20 rpm when the flow rate is 2 μL/min to 20 μL/min. That is, when plural patterns of the patterned light as shown in FIG. 4B is projected and clockwise rotated on the projection region P of the flow channel layer 140 with the structure as shown in FIG. 4B, one of the first micro-particles and the second micro-particles in the liquid are affected by the periodic stepped-impedance effect, thereby guiding the one of the first micro-particles and the second micro-particles to move downward, such that the one of the first micro-particles and the second micro-particles flow out of the LIDEP chip through the outflow opening located at a bottom-right corner of the structure of the flow channel layer 140 as shown in FIG. 4B.

In some embodiments of the present invention, a thickness of the lower substrate 110 and the upper substrate 160 is about 0.7 mm. The thickness of the first electrode layer 120 and the second electrode layer 150 is between 50 nm and 500 nm. The thickness of the semiconductor layer 130 is between 1 μm and 2 μm, preferably 1.2 μm. The thickness of the flow channel layer 140 is between 30 μm and 150 μm, preferably 50 μm. In addition, in some embodiments of the present invention, an included angle between the first channel 143 and the second channel 145 is about 169 degrees. The included angle between the second channel 145 and the third channel 147 is about 22 degrees. A width of the first channel 143, the second channel 145, and the third channel 147 is between 800 μm and 1000 μm. The diameter of the injection opening 142, the first outflow opening 144, and the second outflow opening 146 is about 1.1 mm. The size of the projection region P is between 1 mm×1 mm and 10 mm×10 mm, preferably 1.5 mm×1.5 mm. It is noted that the thicknesses, the widths, and the included angles of the components of the LIDEP chip 100 may adjust according to the actual demand and are not limited to aforementioned values. It is noted that the semiconductor layer 130 may be coated with a biocompatibility optimizing layer (not shown), such as titanium oxide (TiO₂), aluminum oxide (Al₂O₃), zirconium oxide (ZrO₂), hafnium oxide (HfO₂), and combination thereof. A thickness of the biocompatibility optimizing layer is about 1 nm to 100 nm.

Referring to FIG. 1A, the LIDEP chip 100 further includes the first buffer layer 170 and the second buffer layer 180. The first buffer layer 170 is disposed between the first electrode layer 120 and the lower substrate 110. The second buffer layer 180 is disposed between the second electrode layer 150 and the upper substrate 160. The first buffer layer 170 is configured to enhance a lattice match between the first electrode layer 120 and the lower substrate 110. The second buffer layer 180 is configured to enhance the lattice match between the second electrode layer 150 and the upper substrate 160. In other words, the first buffer layer 170 is configured to allow the first electrode layer 120 be more preferably attached on the lower substrate 110, and the second buffer layer 180 is configured to allow the second electrode layer 150 be more preferably attached below the upper substrate 160.

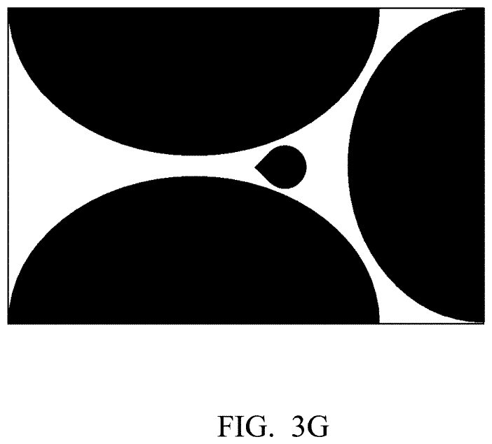

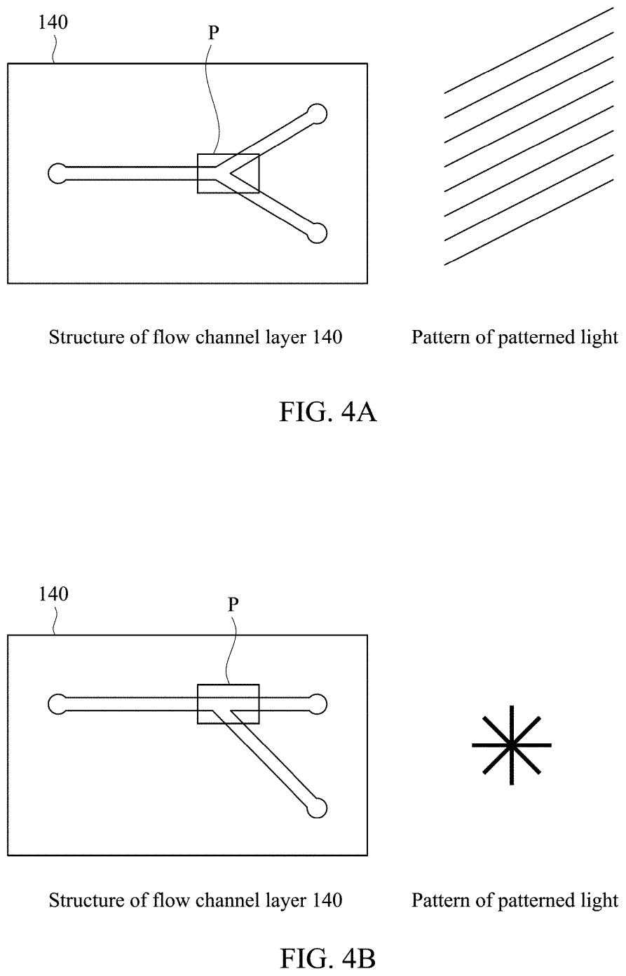

FIG. 5A is a schematic view of an electric field distribution of the LIDEP chip 100 according to the embodiment of the present invention, in which the LIDEP chip 100 is not projected by the patterned light source 300. FIG. 5B is a schematic view of the electric field distribution of the LIDEP chip 100 projected by the patterned light source 300 according to the embodiment of the present invention. As shown in FIG. 5A, the first electrode layer 120 and the second electrode layer 150 are electrically connected to a power source AC, such that an electric field exists between the first electrode layer 120 and the second electrode layer 150. In some embodiments of the present invention, the power source AC provides an AC voltage, in which a peak-to-peak value of the AC voltage is between 1 volt and 50 volt, preferably between 15 volt and 25 volt. A frequency of the AC voltage is between 1 kHz and 100 MHz, preferably between 100 kHz and 1 MHz. However, embodiments of the present invention are not limited thereto. If the patterned light projected by the patterned light source 300 is not projected on the LIDEP chip 100, as shown in FIG. 5A, the electric field between the first electrode layer 120 and the second electrode layer 150 is a uniform electric field. Thus, the first micro-particles C1 and the second micro-particles C2 do not move toward the specific direction. On the other hand, if the patterned light projected by the patterned light source 300 is projected on the LIDEP chip 100, as shown in FIG. 5B, a light induced effect is generated within the projection region P of the flow channel layer 140, and thus the distribution of the electric field between the first electrode layer 120 and the second electrode layer 150 is changed accordingly. Thus, the first micro-particles C1 are affected by the positive dielectrophoresis (DEP) force D1, thereby moving toward a projection position of the patterned light projected by the patterned light source 300, and the second micro-particles C2 are affected by the negative DEP force D2, thereby moving outside the projection position of the patterned light projected by the patterned light source 300.

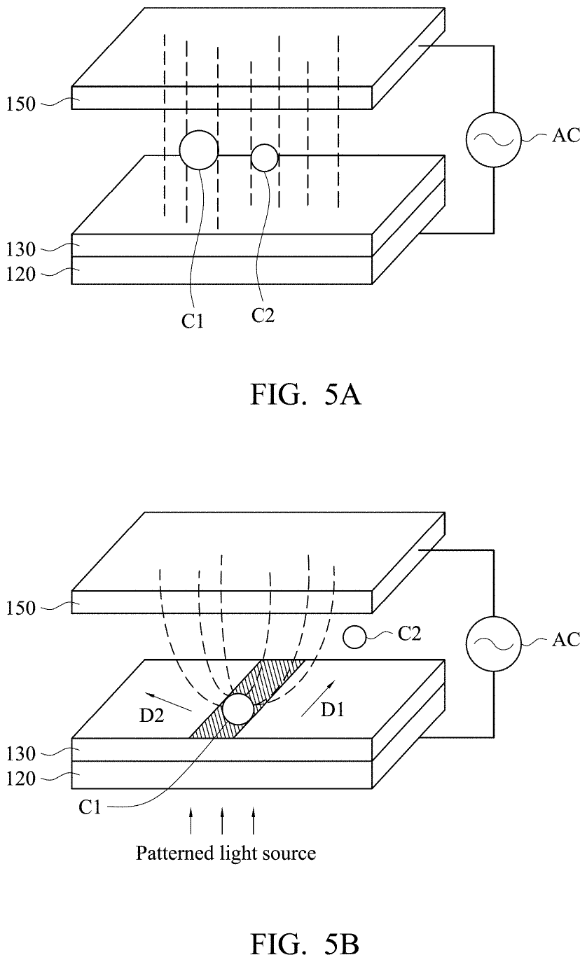

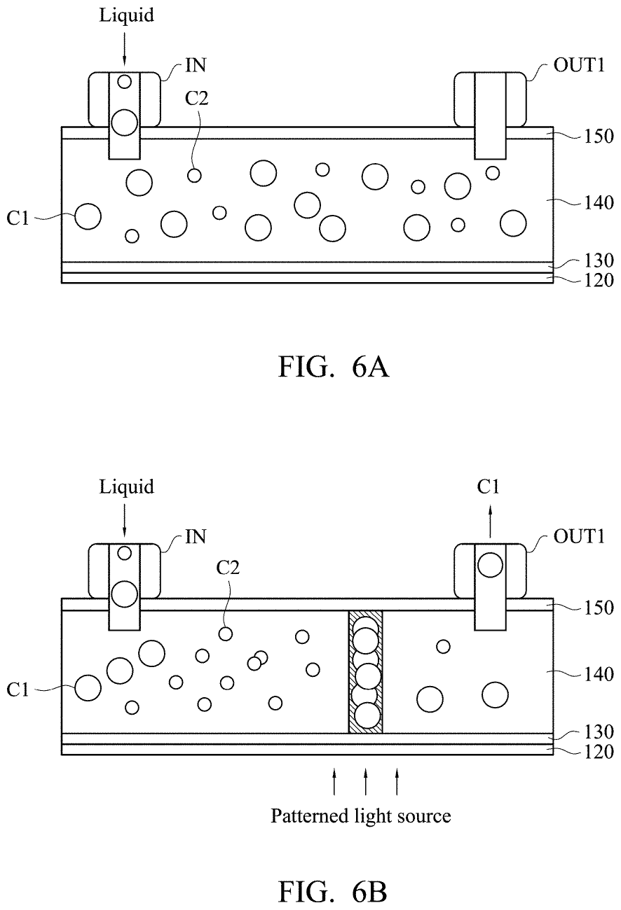

A sorting of the white blood cells and the cancer cells as an example, in which the cancer cells may include the colorectal cancer cells, the lung cancer cells, and the breast cancer cells. Referring to FIG. 6A and FIG. 6B, FIG. 6A is a schematic view of a distribution of the first micro-particles C1 and the second micro-particles C2 of the LIDEP chip 100 according to the embodiment of the present invention, in which the LIDEP chip 100 is not projected by the patterned light source 300, and FIG. 6B is the schematic view of the distribution of the first micro-particles C1 and the second micro-particles C2 of the LIDEP chip 100 projected by the patterned light source 300 according to the embodiment of the present invention. The liquid includes the first micro-particles (such as the cancer cells) and the second micro-particles (such as the white blood cells). The liquid is injected into the flow channel layer 140 through the injection inlet IN. For the convenience of explanation, the upper substrate 110 and the lower substrate 160 are not drawn in FIG. 6A and FIG. 6B. If the patterned light projected by the patterned light source 300 is not projected on the LIDEP chip 100, as shown in FIG. 6A, a distribution of the first micro-particles and the second micro-particles within the flow channel layer 140 is a uniform distribution. If the patterned light projected by the patterned light source 300 is projected on the LIDEP chip 100, as shown in FIG. 6B, an electric field at a projection position of the patterned light projected by the patterned light source 300 is stronger. Thus, the first micro-particles C1 are affected by the positive DEP force, thereby moving toward the projection position of the patterned light projected by the patterned light source 300, and the second micro-particles C2 are affected by the negative DEP force, thereby moving outside the projection position of the patterned light projected by the patterned light source 300. Therefore, the first micro-particles C1 move toward the first outflow outlet OUT1. When the liquid is continually injected into the flow channel layer 140 through the injection inlet IN, the first micro-particles C1 can flow out of the LIDEP chip 100 through the first outflow outlet OUT1.

In some embodiments of the present invention, the patterned light projected by the patterned light source can be continually changed, such that the first micro-particles and the second micro-particles can be more effective to move toward different directions, thereby optimizing the sorting results. In some embodiments of the present invention, the injection inlet of the LIDEP device can be connected to a pump, such that a user can adjust a flow rate of the liquid injected into the LIDEP chip, thereby optimizing the sorting result. For example, the flow rate is between 10 μL/min and 500 μL/min.

To sum up, the LIDEP device of the present invention can perform a sorting process to sort different kinds of the micro-particles in the liquid, thereby benefiting the subsequent analysis instruments to analyze the micro-particles.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light induced dielectrophoresis (LIDEP) device, comprising:
a LIDEP chip comprising:
a first electrode layer;
a second electrode layer disposed opposite to the first electrode layer;
a semiconductor layer disposed between the first electrode layer and the second electrode layer, and
a flow channel layer disposed between the second electrode layer and the semiconductor layer;
wherein the flow channel layer defines a first channel, a second channel and a third channel intersected at a confluence;
wherein the first channel, the second channel and the third channel are configured to guide a liquid, a plurality of first micro-particles, and a plurality of second micro-particles, respectively, wherein the liquid comprises the first micro-particles and the second micro-particles;
wherein the flow channel layer further defines a projection region including the confluence;
a patterned light source configured to project a patterned light on the projection region of the flow channel layer for changing an electric field generating between the first electrode layer and the second electrode layer, wherein a pattern of the patterned light is changed according to a structure of the flow channel layer;
wherein the electric field is configured to guide the first micro-particles and the second micro-particles located within the confluence to move toward the second channel and the third channel, respectively; and
an opaque cartridge covering the LIDEP chip, wherein the opaque cartridge has an opening, and a vertical projection of the opening projected on the flow channel layer overlaps the projection region.

2. The LIDEP device of claim 1,
wherein each of the first electrode layer and the second electrode layer includes a transparent conductive material.

3. The LIDEP device of claim 1,
wherein the semiconductor layer comprises an indirect bandgap material;
wherein a crystal structure of the semiconductor layer is an amorphous structure, a microcrystalline structure, a polycrystalline structure, or a single crystal structure.

4. The LIDEP device of claim 1,
wherein a thickness of the flow channel layer is between 30 μm and 150 μm; and
wherein a size of the projection region is between 1 mm×1 mm and 10 mm×10 mm.

5. The LIDEP device of claim 1,
wherein the flow channel layer further defines an injection opening, a first outflow opening, and a second outflow opening;
wherein the liquid is injected into the first flow channel through the injection opening;
wherein the first micro-particles flow out from the first outflow opening through the second channel; and
wherein the second micro-particle flow out from the second outflow opening through the third channel.

6. The LIDEP device of claim 1, wherein the LIDEP chip further comprises:
a first buffer layer, wherein the first electrode layer is disposed on the first buffer layer; and
a second buffer layer disposed on the second electrode layer.

7. The LIDEP device of claim 6, wherein the LIDEP chip further comprises:
an upper substrate disposed on the second buffer layer; and
a lower substrate, wherein the first buffer layer is disposed on the lower substrate.

8. The LIDEP device of claim 7,
wherein the upper substrate is a transparent substrate; and
wherein the lower substrate is the transparent substrate.

9. The LIDEP device of claim 6,
wherein the first buffer layer is configured to enhance a lattice match between the first electrode layer and the lower substrate; and
wherein the second buffer layer is configured to enhance the lattice match between the second electrode layer and the upper substrate.

10. The LIDEP device of claim 1,
wherein the opaque cartridge has an injection inlet, a first outflow outlet, and a second outflow outlet;
wherein the injection inlet is configured to allow the liquid to be injected into the LIDEP chip;
wherein the first outflow outlet is configured to allow the first micro-particles to flow out of the LIDEP chip; and
wherein the second outflow outlet is configured to allow the second micro-particles to flow out of the LIDEP chip.

11. The LIDEP device of claim 1, wherein a sheet resistance of each of the first electrode layer and the second electrode layer is between 4Ω/□ and 7 Ω/□.

12. The LIDEP device of claim 1, wherein when the patterned light source projects the patterned light on the projection region, the projection region comprises an illuminated region and a non-illuminated region.

13. The LIDEP device of claim 12, wherein a resistance of the illuminated region is different from a resistance of the non-illuminated region.

14. The LIDEP device of claim 13, wherein the resistance of the illuminated region is lower than the resistance of the non-illuminated region.

15. The LIDEP device of claim 13, wherein a difference between the resistance of the illuminated region and the resistance of the non-illuminated region causes a periodic stepped-impedance effect for guiding at least one of the first micro-particles and the second micro-particles.

16. The LIDEP device of claim 1, wherein the LIDEP chip further comprises a biocompatibility optimizing layer; wherein the semiconductor layer is coated with the biocompatibility optimizing layer.

17. The LIDEP device of claim 16, wherein the biocompatibility optimizing layer comprises titanium oxide (TiO₂), aluminum oxide (Al₂O₃), zirconium oxide (ZrO₂), hafnium oxide (HfO₂), and combination thereof.

18. The LIDEP device of claim 16, wherein a thickness of the biocompatibility optimizing layer is between 1 nm and 100 nm.

19. The LIDEP device of claim 1, wherein the semiconductor layer comprises a direct bandgap material or a nanocrystalline material.

20. The LIDEP device of claim 1, wherein a crystal structure of the semiconductor layer is an amorphous and nanocrystalline structure.
